(19) United States
(12) Patent Application Publication
(10) Pub. No.: US 2024/0161149 A1
(43) Pub. Date: May 16, 2024

(54) DYNAMIC CLICK-AD EMBEDDING SYSTEM FOR EBOOKS (KLEVERBOOK)

(71) Applicant: Michael Frederick Schulze, Henderson, NV (US)

(72) Inventor: Michael Frederick Schulze, Henderson, NV (US)

(21) Appl. No.: 18/414,887

(22) Filed: Jan. 17, 2024

Related U.S. Application Data
(60) Provisional application No. 63/619,474, filed on Jan. 10, 2024.

(51) Int. Cl. G06Q 30/0241; G06F 16/34; G06F 16/93; G06F 40/134; G06F 40/166

(52) U.S. Cl. CPC G06Q 30/0241; G06F 16/34; G06F 16/94; G06F 40/134; G06F 40/166

(57) ABSTRACT

The presented system introduces a digital platform designed to monetize eBooks by incorporating non-skippable 30-second click-ads strategically within the content. This software application known as KleverBook serves as a platform for authors, publishers, and other stakeholders to generate revenue through targeted advertising. The inclusion of not skippable ads aims to ensure user engagement, with readers potentially required to interact with the ads by clicking on them. The specific placement of these ads at predefined intervals within the eBook, likely based on factors such as the length of the content or specific chapters, reflects a strategic approach to maximizing ad exposure. While KleverBook presents a potential avenue for monetization in the digital publishing realm, the success of such a platform hinge on maintaining a delicate balance between revenue generation and providing a positive user experience for readers.

### TECHNICAL FIELD

The present invention relates to the field of electronic books and more specifically, systems and methods for eBook Navigation.

### BACKGROUND

The following description includes information that may be useful in understanding the present invention. It is not an admission that any of the information provided herein is prior art or relevant to the presently claimed invention, or that any publication specifically or implicitly referenced is prior art.

In today's digital era, there is a growing demand for innovative approaches that balance the accessibility of digital books with sustainable revenue models for publishers and authors. Traditional monetization methods often face challenges in providing free access to digital content while ensuring profitability.

One prominent issue is the disruptive nature of ad placements in traditional digital advertising models. These placements often interrupt the natural flow of content, leading to user dissatisfaction and a decline in overall engagement. The need for a more integrated and non-intrusive approach to ad placement becomes evident in addressing this challenge. A fundamental dilemma faced by prior art revolves around the effective monetization of digital content. Striking a delicate balance between providing free access to content and ensuring sustainable revenue for authors and publishers remains elusive. Many existing models either compromise accessibility or fail to yield substantial returns, necessitating a solution that redefines the dynamics of revenue generation in the digital publishing landscape.

Furthermore, limited user engagement is a recurring issue in conventional approaches. The inability to captivate readers effectively results in low interaction with displayed ads, undermining the overall effectiveness of advertising efforts. The invention recognizes the need for a more engaging and interactive reading experience that seamlessly integrates advertising content, providing a solution to this challenge. Inefficient content cataloging poses another obstacle, hindering users from navigating through a diverse array of digital books easily. The absence of organized cataloging methods diminishes the user experience and necessitates an inventive solution that enhances content accessibility and discoverability.

This context has led to the exploration of inventive solutions that aim to revolutionize the digital publishing space. The focus is on developing a system that not only facilitates free access to a wide range of digital books but also introduces an interactive and engaging advertising model.

As a result, there exists a need for improvements over the prior art and more particularly for a more efficient way.

### SUMMARY OF THE INVENTION

The disclosed invention introduces a unique concept in the realm of eBook distribution by mirroring the advertising model of commercial television. In this innovative approach, readers can access eBooks for free while encountering unskippable 30-second click-ads strategically placed at specific intervals within the content. Much like commercial television, KleverBook sustains free eBook access through revenue generated from these embedded advertisements. Operated by Decade 2 Publishing (D2P), the KleverBook platform establishes licensing agreements with authors and publishers to curate and offer eBooks. The program then customizes each eBook by integrating the KleverBook Ad Module, inserting ad slots at the end of chapters or approximately every 15 pages. Readers can select and download eBooks from the KleverBook catalog on D2P's website, initiating the loading of 30-second ads into the chosen eBook file. Subsequently, the program uploads the ad-equipped eBook to the reader's device. Despite being free, KleverBooks are exclusively accessible through the KleverBook app.

KleverBook enhances user engagement by implementing a setting that restricts readers from advancing to the next chapter without first interacting with each Chapter Ad. Furthermore, even previously read chapters trigger Chapter Ads when reactivated. Each Chapter Ad includes a hyperlink tab, directing users to the respective retailer's product catalog. These catalogs are exclusively maintained and accessible through eksplode ! Interactive's platform. Downloaded KleverBooks have a 60-day expiration period, necessitating revalidation on the KleverBook portal for continued access. Being an app, KleverBook allows for the dynamic management of Chapter Ads, enabling their removal, replacement, update, or modification on a daily basis. This flexibility ensures a dynamic and evolving advertising experience for readers while maintaining the viability of the free eBook distribution model.

The summary of the invention does not necessarily disclose all the features essential for defining the invention. The invention may reside in a sub-combination of the disclosed features. The various combinations and sub-combination are fully described in the detailed description.

### BRIEF DESCRIPTION OF DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 is a diagram showing the Author's Flow, in accordance with a preferred embodiment of the invention.

FIG. 2 is a diagram showing Retailer Brand and Business Flow, in accordance with a preferred embodiment of the invention.

FIG. 3 is a diagram showing the Reader's initial flow, in accordance with a preferred embodiment of the invention.

### DETAILED DESCRIPTION OF DRAWINGS

Those skilled in the art will understand that when an element or part in the drawings is referred to as being “on” (or “connected” to or “coupled” to or “attached” to) another element, it can be directly on (or attached to) the other element or intervening elements may also be present. Furthermore, relative terms such as “inner”, “outer”, “upper”, “above”, “lower”, “beneath”, and “below”, and similar terms, may be used herein to describe a relationship of one element to another element. It is understood that these terms are intended to encompass different orientations of the device in addition to the orientation depicted in the figures.

A platform redefines the reading experience by providing free access to a diverse range of eBooks while seamlessly integrating unskippable 30-second click-ads at strategic intervals within the content. Operating under licensing agreements with authors and publishers, KleverBook customizes each eBook by inserting ad slots at chapter endings or approximately every 15 pages. Readers can choose eBooks from the KleverBook catalog on D2P's website, initiating a process where the program loads 30-second ads into the selected eBook before uploading it to the reader's device through the KleverBook app. The platform enhances user engagement by enforcing a setting that requires interaction with each Chapter Ad before advancing, and Chapter Ads reappear when previously read chapters are reactivated. With each Chapter Ad featuring a hyperlink tab directing users to a retailer's product catalog maintained exclusively through eksplode! Interactive's platform, KleverBook introduces a dynamic advertising experience. Downloaded KleverBooks expire after 60 days, requiring revalidation for continued access. Being an app, KleverBook allows for the daily removal, replacement, update, or modification of Chapter Ads, ensuring a responsive and evolving advertising model within the framework of free eBook distribution.

The presented application, designed for both computers and mobile phones, introduces a sophisticated computer program known as the “Program,” which serves as a pivotal tool for the integration of advertisements into eBooks. This innovative platform bridges the gap between authors, publishers, and readers by providing a user-friendly interface for uploading and accessing a diverse array of digital books. Administrative staff, referred to as “admin,” play a crucial role in the Program's functionality. They have the capability to strategically insert “ad slots” into eBooks, typically positioned at chapter endings or every 15 pages. These ad slots serve as intentional interruptions within the eBook's text, providing strategic points for the integration of 15- to 30-second digital advertisements stored in the “ad module” database. The “ad module” database is a central component of the Program, efficiently storing digital advertisements in both static and video formats. Admin retains control over the sequence of these ads within the module, ensuring a coherent and strategic presentation to enhance the overall user experience. For readers, the Program offers access to a curated catalog of eBooks, providing a diverse array of reading options within the KleverBook app. Notably, eBook access is restricted to online reading only, reinforcing the exclusivity of content within the app. Upon a reader's selection from the KleverBook catalog, the Program automatically inserts one ad into each predetermined ad slot from its ad module. These ads, termed “chapter ads,” are strategically placed interruptions within the eBook that contribute to the overall reading experience. Importantly, the Program mandates that these chapter ads cannot be skipped, ensuring active engagement with the promotional content. The interactive nature of the reading experience is further enhanced by the integration of a hyperlink tab onto each chapter ad. When activated, these tabs seamlessly transition users to a designated product catalog, creating a direct link between content and commerce. The Program enables users to conduct transactions with retailers directly through the KleverBook app, fostering a seamless connection between reading and commerce.

To ensure a user-centric experience, the Program allows readers to return to the eBook page from where they initially departed to explore a product catalog. Additionally, administrative users have the capability to dynamically replace ads when circumstances necessitate adjustments, ensuring the continued relevance of the embedded advertisements. Adding a personalized touch, the Program enables readers to place bookmarks within eBooks, enhancing the interactivity and user engagement within the digital content. In summary, the described application not only facilitates the seamless integration of advertisements into eBooks but also enriches the overall reading experience by creating a dynamic and interconnected ecosystem within the KleverBook app.

Authors and Publishers are integral stakeholders within the context of the described multimedia conglomerate, Continent 5 Media Group (CSM). CSM, a U.S.A.-based company, boasts diversified divisions encompassing music, publishing, mobile gaming, digital art, and marketing. Authors and Publishers play a pivotal role within the publishing division of CSM, responsible for creating and supplying content for various platforms. The publishing division of CSM operates a website where Authors and Publishers have the opportunity to upload their books for sale or for integration into D2P's innovative KleverBook program. This platform serves as a digital gateway for content creators, facilitating the seamless transition of traditional literary works into the digital realm. Authors and Publishers are provided with a means to reach a broader audience and engage with modern reading habits. The marketing division of CSM, intertwined with the broader multimedia landscape, underscores the company's commitment to comprehensive brand promotion and audience engagement. This diverse approach ensures that digital content, including books, is strategically positioned in the market, creating synergy between content creation and effective marketing strategies. A ‘digital book’ in this context refers to the electronic format of a book that is accessible for reading on various electronic devices such as mobile phones, tablets, computers, and websites. This adaptation caters to the evolving preferences of modern readers who seek convenience and accessibility in their reading experiences. Within the framework of D2P's KleverBook program, a ‘database’ is maintained to store digital advertisements. This database serves as a centralized repository for 15- to 30-second digital advertisements in static or video formats. It ensures an organized and efficient management of promotional content, ready for integration into eBooks for a dynamic reading experience. Terms like ‘Chapter Ad’ describe an ‘interruption’ deliberately inserted into an eBook's text, creating a strategic pause where unskippable 30-second advertisements are seamlessly integrated. These Chapter Ads serve as a unique method of revenue generation, offering Authors and Publishers a monetization avenue while engaging readers with carefully curated promotional content. The term ‘Unskippable Ad’ emphasizes the nature of the 30-second advertisement, indicating that readers are unable to bypass or skip over these promotional segments. This design ensures a captive audience, providing valuable exposure to the embedded advertisements within the eBook. A ‘Click Ad’ introduces an interactive element within the digital advertisement, featuring a tab that, when activated, redirects the reader to a designated page. This functionality not only enhances user engagement but also connects readers directly to product catalogs, creating a seamless transition between content and commerce. The concept of ‘Level of Value’ pertains to the priority and placement given to an advertisement within the KleverBook program. This strategic consideration influences the prominence of ads, ensuring optimal visibility and effectiveness in capturing the reader's attention. For Authors and Publishers interested in participating in D2P's KleverBook program, an account creation process is initiated through CSM's website. The registration, available at www.ContinentSMedia.com or www.CSM.world, redirects them to D2P's website. Here, they can establish their page, followed by the upload of digital copies of each book intended for submission to the KleverBook program. This structured process ensures a seamless onboarding experience for content creators seeking to engage with this innovative digital publishing platform.

An integrated digital publishing system is provided, allowing Authors and Publishers to effortlessly engage with the platform. The system features an intuitive interface facilitating account creation and seamless submission of digital books. Upon submission, Authors and Publishers are redirected to a dedicated platform for profile creation, including the input of metadata, descriptions, and cover images. The system employs a secure database to store digital book submissions, ensuring a user-authenticated and activated account process. This cohesive system seamlessly integrates submitted books into the KleverBook program, making them readily available in the catalog. Additionally, the platform incorporates a notification system to keep Authors and Publishers informed about the status of their submissions, and a tracking mechanism allows monitoring of digital book performance metrics within the KleverBook program. This comprehensive and user-friendly approach enhances the overall experience for Authors and Publishers in the digital publishing ecosystem.

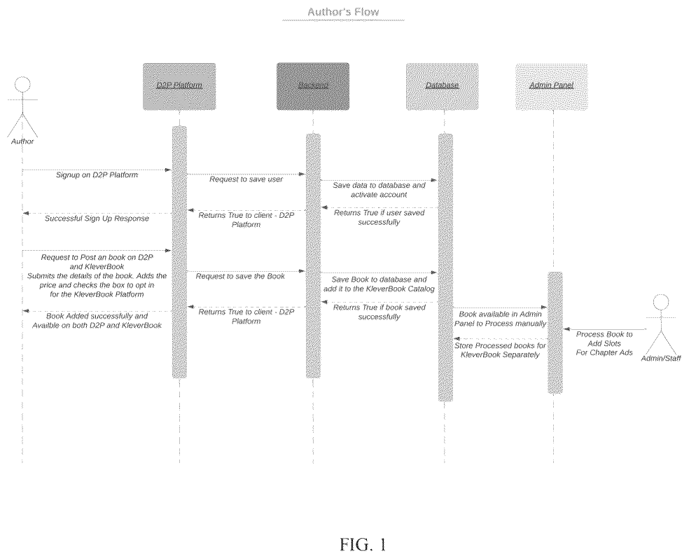

FIG. 1 is a diagram showing the Author's Flow, in accordance with a preferred embodiment of the invention. The author's flow involves a seamless interaction between the author, the D2P platform, the backend server, and the database. The author's flow described outlines the step-by-step process an author undergoes when signing up on the D2P (Decade 2 Publishing) platform. This process involves multiple stages, interactions with the D2P platform, and backend operations. The below is a breakdown of the process:

Author Initiates Signup: The process begins with an author expressing the intent to sign up on the D2P platform. This typically involves visiting the D2P website or application.

Signup on D2P Platform: The author provides necessary information and completes the signup process on the D2P platform. This information may include personal details, contact information, and other relevant data required for account creation.

D2P Platform Sends User Data to Backend: Upon successful completion of the signup process, the D2P platform sends a request to save the user's data to the backend. This is the server-side component responsible for handling data operations.

Backend Receives Request and Saves Data to Database: The backend, upon receiving the request from the D2P platform, processes the information provided by the author. It then saves this data to the database, ensuring that the author's account details are securely stored for future reference.

Activate Account: As part of the backend operations, the system activates the author's account, making it accessible and functional within the D2P platform. Activation may involve verifying the provided information, ensuring its accuracy and completeness.

Database Returns True if User Saved Successfully: After successfully saving the user's data in the database and activating the account, the database component returns a confirmation status. If the user's data is saved successfully, the database returns a True status to the backend.

Backend Returns True to Client (D2P Platform): The backend, having received confirmation from the database, communicates the successful user-saving operation back to the D2P platform. This confirmation is crucial for ensuring that the signup process has been completed without errors.

D2P Platform Updates User Interface: The D2P platform, upon receiving the True status from the backend, updates its user interface. This may involve displaying a success message to the author, indicating that their signup was successful.

Successful Signup Response to Author: Finally, the D2P platform sends a successful signup response to the author. This response may include a confirmation message, login credentials, or any additional information relevant to the author's newly created account.

Further, the outlined flow illustrates the steps involved when an author attempts to add a book on the D2P (Decade 2 Publishing) platform.

Database Processing: The process begins with the D2P platform sending a request to the backend to save information about a new book into the database.

Backend Receives Request and Saves Book Data: The backend, upon receiving the request from the D2P platform, processes the information related to the new book. It then saves this book data to the database, ensuring secure storage and association with the author's account.

Database Returns True if Book Saved Successfully: After successfully saving the book information in the database, the database component returns a True status to the backend. This status confirms that the book has been added successfully.

Backend Returns True to Client (D2P Platform): The backend, having received confirmation from the database, communicates the successful book-saving operation back to the D2P platform. This True status indicates that the book addition process has been completed without errors.

D2P Platform Updates User Interface: The D2P platform, upon receiving the True status from the backend, updates its user interface. This may involve displaying a success message to the author, indicating that the book has been added successfully.

Book Added Successfully on D2P and KleverBook: The D2P platform, having received confirmation, proceeds to make the book available not only on the D2P platform but also on the KleverBook program. This ensures broader visibility and accessibility for readers.

Confirmation to Author: The D2P platform sends a confirmation message to the author, notifying them that the book has been added successfully. This message may include relevant details such as the book's availability on both the D2P platform and KleverBook.

Once a book is made available for processing in the admin panel, particularly for the addition of slots for chapter ads within the context of the KleverBook program, the following steps take place:

Database Indicates Book Availability in Admin Panel: The process initiates with the database indicating that a particular book is available for further processing in the admin panel. This may be triggered by the backend system recognizing that a book has been submitted or needs attention.

Admin Panel Displays Book for Manual Processing: The admin panel, a dedicated interface for administrative tasks, displays the book that requires manual processing to add slots for chapter ads. This interface is accessible to admin or staff members responsible for overseeing the placement of advertisements within eBooks.

Admin/Staff Manually Processes Book to Add Slots for Chapter Ads: Admin or staff members, using the admin panel tools, manually process the book by adding slots for chapter ads. This involves strategically determining the placement of interruptions within the eBook's text, ensuring optimal engagement with unskippable 30-second advertisements.

Admin Panel Records Processed Books for KleverBook: Once the manual processing is completed, the admin panel records and stores the processed book separately, specifically marking it for integration into the KleverBook program. This segregation ensures that books with added slots for chapter ads are appropriately identified for the next steps in the workflow.

Database Updates with Processed Book Information: The admin panel communicates with the database, updating it with information about the processed book. This may include details about the added slots for chapter ads, ensuring that the database reflects the changes made during the manual processing.

Conclusion of Book Processing Workflow: With the completion of these steps, the book has undergone manual processing to incorporate slots for chapter ads. The processed book is now appropriately marked and stored separately, ready for the subsequent stages of integration into the KleverBook program.

The administrative functions within D2P's KleverBook program encompass several key processes. Each digital book uploaded by an author or publisher undergoes modification with the insertion of Ad Slots for Chapter Ads, strategically placed at the end of each chapter or approximately every 15 pages. These modified eBooks are meticulously cataloged on D2P's site, organized alphabetically by author, title, and category. Chapter Ads, featuring hyperlinks leading to corresponding retailer product catalogs on eksplode!'s site, are integral to the reading experience. Notably, these Chapter Ads are unskippable, ensuring engagement throughout their 30-second duration before unlocking the subsequent chapter. A chapter is deemed read if the user remains within the section between Ad Slots for the designated time. Readers exploring retailer catalogs via click ads can seamlessly return to their KleverBook page with a simple click. Visitors to D2P's website have the option to view the company's book catalog, make purchases, or opt to download the KleverBook app for free eBook access. Upon selecting an eBook for reading, the KleverBook software promptly loads Chapter Ads into the designated Ad Slots. Each Ad, featuring a hyperlink tab, directs users to the retailer's product catalog on eksplode!'s platform or the brand's website when live and activated. CSM's administration possesses the capability to move and install Ads into Ad Slots as a single unit, with the inserted Ads becoming live once the book is uploaded onto a user's device. The Ad Module's sophisticated functionality arranges ads chronologically based on Retailer/Brand Level, with higher bids/Levels taking precedence at the top of the list. The system ensures automatic and perpetual updates to the Ad Module, maintaining the hierarchy of ads and accommodating changes based on bid levels. This comprehensive set of administrative functions underscores the program's dynamic approach to advertising integration within the KleverBook platform.

The digital publishing system combines several key features to optimize user engagement and advertising effectiveness. It seamlessly integrates non-skippable Chapter Ads into digital books, strategically placing them at chapter endings for an enriched reading experience. The system meticulously organizes modified eBooks, categorizing them alphabetically by author, title, and category to enhance accessibility. Hyperlinks embedded within Chapter Ads facilitate interactive engagement, directing readers to corresponding retailer product catalogs. To ensure a captivating user experience, Chapter Ads are designed to be non-skippable, displaying dynamically for a predetermined duration before unlocking subsequent chapters. The system also tracks readership by considering a chapter as read if the user remains within the section between Ad Slots for a specified time. User convenience is enhanced through features such as a ‘Return’ tab for easy navigation to the KleverBook page. The perpetual update system prioritizes competitive advertising by arranging Chapter Ads based on Retailer/Brand Level, maintaining a dynamic and engaging environment within the digital publishing system.

Retailers and company brands aiming to engage with D2P's KleverBook program initiate the process by establishing an account with Continent 5 Media Group (CSM). Upon successful registration with CSM, retailers are seamlessly directed to eksplode!'s website, where they can meticulously craft their company page, upload their product catalog, and submit static or 30-second video advertisements. These ads are efficiently stored within CSM's Ad Module, organized based on Level Value, date, and time, ensuring a structured and prioritized approach to their integration into the KleverBook program. This streamlined process enables retailers and brands to effectively participate in the dynamic advertising ecosystem of KleverBook.

In the digital publishing realm, a comprehensive system is designed to seamlessly accommodate Retailers and Brands within the KleverBook program. The system begins with a user-friendly registration interface, directing these entities to a dedicated platform. On this platform, Retailers and Brands can effortlessly create company profiles, upload product catalogs, and submit static or 30-second video advertisements. A secure database efficiently organizes and stores these submissions, employing categorization based on Level Value, date, and time. The system incorporates a sophisticated bid/level prioritization algorithm within the ad module database, ensuring optimal advertisement display order by considering bid values, relevance, and historical performance. This prioritization process is complemented by a responsive backend that facilitates the swift and accurate processing of Retailer and Brand submissions. Notably, a bid submission feature empowers these entities to actively participate in determining the prominence of their advertisements, thereby enhancing visibility and efficacy within the KleverBook program.

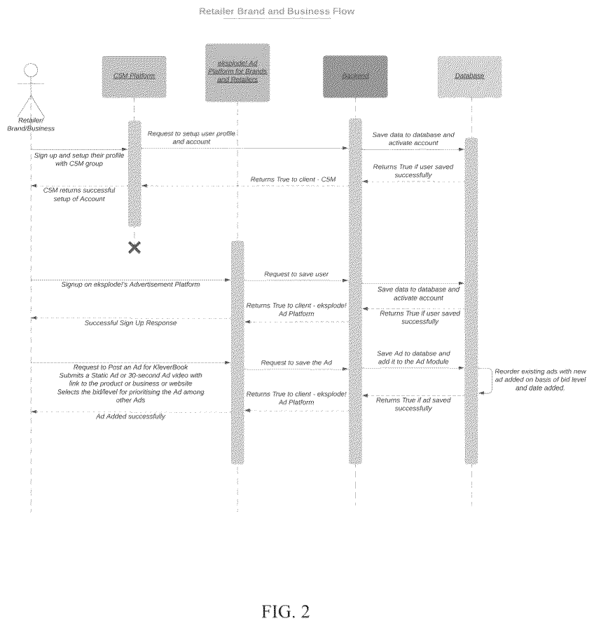

FIG. 2 is a diagram showing Retailer Brand and Business Flow, in accordance with a preferred embodiment of the invention. The process for a Retailer, Brand, or Business to establish their profile and account within the C5M Group involves a series of steps that seamlessly integrates various platforms. This ensures a transparent and reliable onboarding process for Retailers, Brands, or Businesses, with each platform confirming the successful setup of the user account. The below is a detailed breakdown:

Retailer/Brand/Business Initiates Sign Up: The process commences with the Retailer, Brand, or Business expressing the intent to join the C5M Group. They initiate the sign-up process.

Sign Up and Setup Profile with C5M Group: The entity completes the sign-up process by providing necessary information and setting up their profile within the C5M Group, ensuring that their details are accurately represented.

C5M Platform Request for User Profile and Account Setup: Once the profile is set up, the entity sends a request to the C5M Platform, prompting the setup of their user profile and account.

Eksplode! Ad Platform for Brands and Retailers: The request from the C5M Platform is then directed to the eksplode! Ad Platform, a specialized platform catering to the needs of Brands and Retailers for advertising purposes.

Backend Operations: The backend, a crucial component responsible for managing data operations, receives the request for user profile and account setup from the eksplode! Ad Platform.

Save Data to Database and Activate Account: The backend processes the request, saving the pertinent data, including user profile information, to the database. Additionally, the account is activated, ensuring that the Retailer, Brand, or Business gains access to the full functionality of the C5M and eksplode! platforms.

Database Interaction: The backend interacts with the database to securely store the user profile and account details, confirming the successful activation of the account for the Retailer, Brand, or Business.

Database Processing: After the backend receives the request for user profile and account setup, it interacts with the database to save the user's information. The database returns a confirmation status, indicating whether the user's data was saved successfully.

Backend Verification: The backend, having processed the database response, verifies the status. If the user's data is successfully saved, the backend returns a “True” status.

Client Interaction—C5M: The client, in this case, the C5M platform, receives the “True” status from the backend. This status confirms the successful setup of the user's account.

C5M Confirms Successful Account Setup: C5M processes the status received from the backend and confirms the successful setup of the user's account within its platform.

Notification to Retailer/Brand/Business: C5M then communicates the successful setup of the account back to the Retailer, Brand, or Business. This notification serves as confirmation that their user profile and account have been successfully established within the C5M ecosystem.

The signup process for Retailers, Brands, or Businesses on eksplode!'s Advertisement Platform involves a series of steps to ensure a successful and seamless onboarding experience.

Retailer/Brand/Business Initiates Signup: The process begins with the Retailer, Brand, or Business expressing their intent to join eksplode !'s Advertisement Platform, initiating the signup process.

eksplode! Ad Platform for Brands and Retailers: The entity navigates through eksplode!'s specialized Advertisement Platform designed for Brands and Retailers, where they provide necessary information during the signup process.

Request to Save User Sent to Backend: After the signup information is entered, a request to save the user is sent from the eksplode! Ad Platform to the backend, the server-side component handling data operations.

Backend Processes and Saves Data to Database: The backend processes the request, saving the user's information, including the Retailer, Brand, or Business details, to the database.

Database Confirmation—Returns True: The database returns a confirmation status, indicating whether the user's data was successfully saved. A “True” status is returned if the data is saved successfully.

Backend Verification and Response: The backend, upon receiving the confirmation from the database, verifies the status and, if successful, returns a “True” status to the client.

Client Interaction—eksplode! Ad Platform: The client, in this case, the eksplode! Ad Platform receives the “True” status from the backend, confirming the successful signup process.

Successful Sign-Up Response to Retailer/Brand/Business: eksplode! Ad Platform generates a successful sign-up response, communicating to the Retailer, Brand, or Business that their account has been successfully activated within the Advertisement Platform.

Further, the process for a Retailer, Brand, or Business to post an advertisement for KleverBook through eksplode!'s Ad Platform involves several steps to ensure effective ad management. This sequence of steps ensures a streamlined process for Retailers, Brands, or Businesses to post ads on eksplode !'s Ad Platform, with efficient communication between the client, backend, and database components. The steps are explained below:

Retailer/Brand/Business Requests to Post an Ad: The process starts with the Retailer, Brand, or Business expressing the intention to post an ad for KleverBook. They provide essential details such as a static ad or a 30-second video ad with a link to the product, business, or website.

eksplode! Ad Platform for Brands and Retailers: The entity utilizes eksplode !'s specialized Ad Platform designed for Brands and Retailers to initiate the ad posting process. They also select the bid/level to prioritize the ad among other advertisements.

Request to Save the Ad Sent to Backend: After entering the ad details and bid/level, a request is sent from eksplode!'s Ad Platform to the backend, the server-side component handling data operations.

Backend Saves Ad to Database and Adds to the AdModule: The backend processes the request, saving the ad details, including the link and bid/level, to the database. Simultaneously, the ad is added to the AdModule, a component responsible for managing digital advertisements.

Database Reorders Existing Ads with New Ad: The database, in coordination with the backend, reorders the existing ads within the AdModule, considering factors like bid level and the date the ad was added. This ensures a dynamic arrangement of ads for optimal prioritization. The application incorporates an advanced bid/level prioritization algorithm within its ad module database to optimize the display order of stored advertisements. This dynamic algorithm assigns priority levels based on bid values, giving precedence to higher bids and ensuring a fair and competitive advertising environment. Operating in real-time, it adapts to changes in bid values, maintaining an up-to-date and responsive advertising landscape. Beyond bid considerations, the algorithm dynamically adjusts display order based on factors such as ad relevance, engagement metrics, and historical performance, enhancing the overall user experience with more engaging and pertinent advertisements. Administrators have the flexibility to fine-tune display order preferences, fostering a customizable and adaptable approach to ad prioritization and ensuring fairness in the marketplace. In summary, the bid/level prioritization algorithm enriches the application's ad module, providing an intelligent and versatile mechanism to optimize ad visibility and effectiveness.

Database Confirmation—Returns True: The database returns a confirmation status, indicating whether the ad was successfully saved. A “True” status is returned if the ad is saved successfully.

Backend Verification and Response: The backend, upon receiving the confirmation from the database, verifies the status and, if successful, returns a “True” status to the client.

Client Interaction—eksplode! Ad Platform: The client, in this case, eksplode !'s Ad Platform, receives the “True” status from the backend, confirming the successful addition of the ad.

Ad Added Successfully Response to Retailer/Brand/Business: eksplode !'s Ad Platform generates a response indicating that the ad has been successfully added, providing confirmation to the Retailer, Brand, or Business.

Readers interested in accessing eBooks through D2P's KleverBook Program can visit www.Decade2Publishing.com, where they can sign up and explore a catalog of available eBooks for online reading. The KleverBook program ensures a deliberate engagement strategy by blocking a reader's access to the next chapter or following page until the full 30-second Ad (or Ads) is shown, fostering uninterrupted exposure to embedded advertisements. Notably, the KleverBook software provides flexibility by allowing the reshowing of a Chapter Ad or the introduction of a new one, enhancing the variety of content presented to the reader. The software's tracking capabilities extend to monitoring the hyperlink jumps activated by a reader, ensuring a seamless return to the exact page from where the jump occurred. In instances where a reader exits the KleverBook app, an automatic bookmarker is inserted, facilitating a convenient return to the last viewed page upon subsequent access. Additionally, the downloaded KleverBook has a set expiration date, expiring on the 60th day from the time and date the reader initially requested it, introducing a time-bound element to the accessibility of downloaded content. These reader specifications highlight the program's emphasis on user engagement, personalized navigation, and time-sensitive access to digital content within the KleverBook platform. The described digital publishing system outlines a user-friendly and efficient experience for Readers within the KleverBook program. Readers can seamlessly explore and download eBooks from the KleverBook catalog on D2P's platform. Through integration with the KleverBook App or Platform, Readers initiate download requests that trigger the backend to fetch eBooks enriched with Chapter Ads from the Ad Module. The Ad Module efficiently retrieves Ads based on priority for Chapter Ad Slots, enhancing the eBooks' content. The backend securely saves the enriched book against the user with a predetermined viewing expiry date. This process ensures a smooth and secure book-saving operation, enabling Readers to access downloaded books within their library on the KleverBook App or Platform for the specified duration, enhancing their overall reading experience.

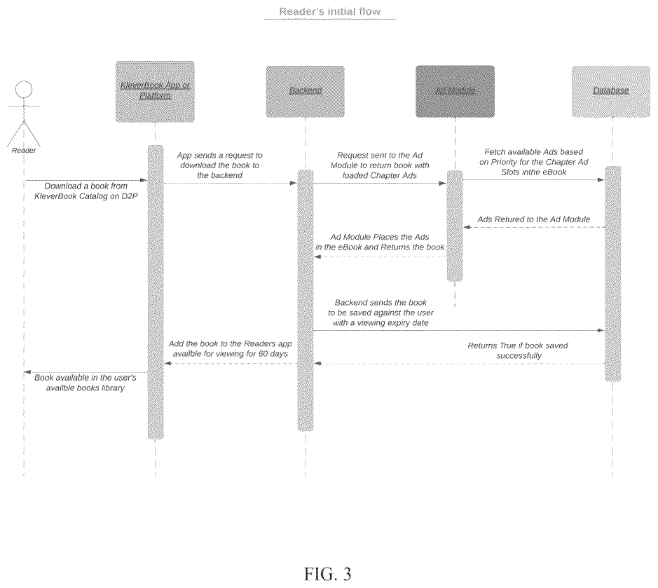

FIG. 3 is a diagram showing the Reader's initial flow, in accordance with a preferred embodiment of the invention. The reader's flow within the KleverBook platform involves a series of steps to facilitate the download of a book and ensure the integration of Chapter Ads. The below is a detailed breakdown:

Reader Initiates Download: The process commences with the reader selecting and downloading a book from the KleverBook Catalog on D2P.

KleverBook App or Platform: The downloaded book is accessed through the KleverBook app or platform, providing the reader with a user-friendly interface for their digital reading experience.

App Sends Download Request to Backend: The KleverBook app sends a download request to the backend, the server-side component responsible for handling data operations and facilitating interactions between the app and the core system.

Backend Processes Download Request: The backend, upon receiving the download request, processes the necessary information to ensure a smooth download experience for the reader.

Request Sent to Ad Module for Loaded Chapter Ads: As part of the backend operations, a request is sent to the Ad Module to retrieve the book along with loaded Chapter Ads. This ensures that the downloaded book includes strategically placed interruptions for unskippable 30-second advertisements.

Ad Module Fetches Available Ads Based on Priority: The Ad Module, responsible for managing digital advertisements, fetches available Chapter Ads based on their priority. The priority may be determined by factors such as bid value, relevance, or a predefined level, ensuring optimal placement within the eBook.

Database Involvement: In the process, the Ad Module interacts with the database to fetch the relevant Chapter Ads, ensuring that the advertisements align with the specified priority and configuration for the Chapter Ad Slots in the eBook.

The continuation of the reader's flow within the KleverBook platform involves the retrieval and placement of advertisements within the downloaded eBook. The below explains the steps:

Ads Returned to the Ad Module: Following the interaction with the database, the Ad Module receives the relevant Chapter Ads based on priority and configuration.

Ad Module Places the Ads in the eBook: The Ad Module, equipped with the fetched Chapter Ads, strategically places them within the eBook. This process involves inserting unskippable 30-second advertisements at predefined intervals, such as at the end of each chapter or roughly every 15 pages.

Ad Module Returns the Book: Once the Chapter Ads are successfully integrated into the eBook, the Ad Module returns the modified book with embedded advertisements.

Backend Operations: The backend, having received the book with strategically placed Chapter Ads, ensures the final processing and delivery of the modified eBook to the KleverBook app or platform.

In the reader's flow within the KleverBook platform, after the integration of Chapter Ads, the backend plays a crucial role in finalizing the process and managing the user's access to the modified eBook.

Backend Operations: Following the successful placement of Chapter Ads within the eBook, the backend takes charge of the final processing steps.

Backend Sends the Book to be Saved Against the User: The backend sends the modified eBook, now featuring integrated Chapter Ads, to be saved against the specific user who initiated the download. This association ensures that the user receives the personalized version of the eBook with strategically placed advertisements.

Viewing Expiry Date Assignment: As part of the backend operations, the system assigns a viewing expiry date to the saved eBook. This expiry date indicates the time until which the user has access to the downloaded and modified content within the KleverBook platform.

Database Interaction: The backend interacts with the database to securely store the modified eBook against the user's account, along with the associated viewing expiry date. This information is crucial for managing user access and ensuring compliance with the designated timeframe.

A streamlined experience for readers within the KleverBook platform, offering access to modified eBooks with integrated Chapter Ads for a designated timeframe is described further in the steps below.

Database Operations: Upon successful saving of the modified eBook against the user, the database returns a confirmation, typically a ‘True’ status, indicating that the book has been saved successfully.

Backend Actions: The backend, receiving the confirmation from the database, proceeds to add the modified eBook to the reader's app, making it available for viewing. This addition is accompanied by setting a specific timeframe, typically 60 days, during which the user can access and view the book within the KleverBook app or platform.

KleverBook App/Platform Interaction: As a result of the backend's actions, the modified eBook becomes available in the user's library of available books within the KleverBook app or platform. This ensures easy accessibility for the reader to locate and access the integrated eBook with Chapter Ads.

Reader Experience: For the reader, the modified eBook with strategically placed Chapter Ads is now present in their library of available books within the KleverBook app or platform. The reader can navigate to their library and access the book for reading within the specified 60-day period.

While the subject invention is described and illustrated with respect to certain preferred and alternative embodiments, it should be understood that various modifications can be made to those embodiments without departing from the subject invention, the scope of which is defined in the following claims.

1. An application designed for computers and mobile phones, embodying a comprehensive system that facilitates a digital publishing process, comprising:
a sophisticated computer program empowering authors and publishers to seamlessly upload their books electronically;
administrative capabilities allowing the strategic insertion of “ad slots” within eBooks;
intelligent recognition of “ad slots” as deliberate interruptions in the textual flow of eBooks;
integration of a dynamic database, termed an “ad module,” dedicated to storing 15- to 30-second digital advertisements in static or video formats, available for retrieval;
adherence to a carefully orchestrated order for ad storage, dictated by administrative preferences;
empowerment of readers to peruse and select eBooks conveniently from the curated KleverBook catalog;
restriction of eBook accessibility to online reading exclusively, with no provision for downloads;
automatic insertion of precisely one “chapter ad” into each designated ad slot upon the selection of an eBook, hereby referred to as “chapter ads”;
imposition of a constraint disallowing the skipping of chapter ads to ensure a consistent viewing experience;
inclusion of a strategically placed hyperlink tab on each chapter ad, seamlessly transporting readers to a meticulously curated product catalog upon activation;
provision of an integrated transactional feature, facilitating users to engage in seamless transactions with retailers directly through the KleverBook app;
user-friendly functionality enabling readers to effortlessly return to the exact eBook page they left off after exploring a product catalog;
administrative flexibility, empowering administrators to dynamically replace ads in response to evolving circumstances;
empowerment of readers to personalize their eBook experience by placing bookmarks within the digital pages.

2. The application designed for computers and mobile phones of claim 1, wherein insertion of “ad slots” within eBooks, is positioned at the conclusion of each chapter or approximately every 15 pages.

3. The application designed for computers and mobile phones of claim 1, further incorporating a bid/level prioritization algorithm within the ad module database to optimize the display order of stored ads.

4. A digital advertising platform for an application designed for computers and mobile phones of claim 1, comprising:
a user interface for receiving ad submissions from advertisers;
a backend server for processing and storing ad data;
an AdModule for dynamically managing the display order of ads based on bid levels.

5. The digital advertising platform of claim 4, wherein the user interface enables advertisers to submit static ads or 30-second video ads with hyperlinks to products, businesses, or websites.

6. The digital advertising platform of claim 4, wherein the AdModule dynamically reorders existing ads along with new ads based on their bid levels and the date of addition.

7. A digital publishing system, comprising:
an interface for Authors and Publishers to create accounts and submit digital books;
a redirect mechanism seamlessly guiding registered Authors and Publishers to a dedicated platform for creating book profiles;
a database for storing uploaded digital books submitted by Authors and Publishers for integration into a KleverBook program;
a user authentication and activation process within the database ensuring secure and activated accounts for Authors and Publishers;
a seamless integration between the digital publishing system and the KleverBook program, allowing for the availability of submitted books in the KleverBook catalog.

8. A system to facilitate seamless participation for Retailers and Brands within the KleverBook program in a digital publishing environment of claim 7, comprising:
a registration interface enabling Retailers and Brands to set up accounts and initiate engagement with the KleverBook program;
a redirection mechanism guiding registered entities to a dedicated platform for the creation of company profiles, including the upload of product catalogs and static or 30-second video advertisements;
a database for securely storing uploaded product catalogs and advertisements, categorizing them based on Level Value, date, and time; (d) An integrated bid/level prioritization algorithm within the ad module database, optimizing the display order of stored advertisements based on bid values, relevance, and historical performance;
a responsive backend facilitating the efficient processing of Retailer and Brand submissions and ensuring accurate placement within the KleverBook program;
a bid submission feature allowing Retailers and Brands to participate in the prioritization process by selecting bid values to determine the prominence of their advertisements.

9. A seamless and user-centric digital publishing system optimizing the experience for Readers within the KleverBook program of claim 7, comprising:
an accessible platform allowing Readers to explore and download eBooks from the KleverBook catalog on Decade 2 Publishing (D2P);
integration with the KleverBook App or Platform, enabling Readers to send download requests to the backend;
a responsive backend communicating with the Ad Module to retrieve eBooks loaded with Chapter Ads for Readers;
an Ad Module efficiently fetching available Ads based on Priority for Chapter Ad Slots in the eBook from the database;
a database returning Ads to the Ad Module, which places them in the eBook and returns the enriched book to the backend;
a backend, in turn, saving the book against the user with a viewing expiry date in the database;
ensuring a secure and successful book-saving process, allowing Readers to access the downloaded book in their library on the KleverBook App or Platform for a predetermined period.

10. A digital publishing system comprising:
modification functionality facilitating the seamless insertion of non-skippable Chapter Ads within digital books, enhancing user engagement;
organizational features ensuring systematic cataloging of modified eBooks on a platform, arranging them alphabetically by author, title, and category for easy accessibility;
presentation elements strategically placing non-skippable Chapter Ads at the conclusion of each chapter or approximately every 15 pages, optimizing the reading experience;
hyperlink integration enabling dynamic interaction by incorporating hyperlinks within Chapter Ads, seamlessly directing readers to corresponding retailer product catalogs on a designated platform;
temporal control mechanisms preventing the skipping of Chapter Ads, guaranteeing their complete and dynamic display for a predetermined duration before unlocking subsequent chapters;
readership tracking functionalities defining a chapter as read if the user remains within the section between Ad Slots for 30 seconds, providing an accurate metric of user engagement;
user convenience attributes such as a ‘Return’ tab for users accessing retailer catalogs through click ads, ensuring seamless navigation and enhancing user satisfaction;
an update system perpetually arranging Chapter Ads in chronological order based on Retailer/Brand Level, maintaining a dynamic and competitive advertising environment within the digital publishing system.
